(19) United States
(12) Patent Application Publication
(10) Pub. No.: US 2015/0220150 A1
(43) Pub. Date: Aug. 6, 2015

(54) VIRTUAL TOUCH USER INTERFACE SYSTEM AND METHODS

(71) Applicant: Google Inc., Mountain View, CA (US)

(72) Inventors: Christian Plagemann, Menlo Park, CA (US); Hendrik Dahlkamp, San Francisco, CA (US); Varun Ganapathi, Palo Alto, CA (US)

(73) Assignee: Google Inc., Mountain View, CA (US)

(21) Appl. No.: 13/758,761

(22) Filed: Feb. 4, 2013

Related U.S. Application Data
(60) Provisional application No. 61/598,598, filed on Feb. 14, 2012.

(51) Int. Cl. G06F 3/01

(52) U.S. Cl. CPC G06F 3/017

(57) ABSTRACT

In one implementation, a computer program product can be tangibly embodied on a non-transitory computer-readable storage medium and include instructions that, when executed, are configured to detect a gesture defined by an interaction of a user within a working volume defined above a surface. Based on the detected gesture, a gesture cursor control mode can be initiated within the computing device such that the user can manipulate the cursor by moving a portion of the hand of the user within the working volume. A location of the portion of the hand of the user relative to the surface can be identified within the working volume and a cursor can be positioned within a display portion of the computing device at a location corresponding to the identified location of the portion of the hand of the user within the working volume.

### RELATED APPLICATIONS

This application claims priority under 35 U.S.C. §119 to Provisional Patent Application Ser. No. 61/598,598, entitled “VIRTUAL TOUCH USER INTERFACE SYSTEM AND METHODS” filed on Feb. 14, 2012. The subject matter of this earlier filed application is hereby incorporated by reference.

### TECHNICAL FIELD

This description relates to a user interface system and method associated with a computing device.

### BACKGROUND

Many known computing devices can have several mechanisms through which a user may interact with (e.g., trigger) one or more functions of the computing device. For example, dedicated user interface devices such as keyboards, mouse devices, touch screen displays and/or so forth, through which a user may interact with a computing device to perform one or more computing functions, can be connected with and/or integrated into the computing device. Such user interface devices can require a user of the computing device to work within multiple working regions associated with the computing device. For example, a mouse may be located on a surface adjacent a computing device and a keyboard may be located on the computing device itself. Thus, the user must move his or her hand(s) between two different working regions while changing between a keyboard function (e.g., typing) and a cursor function (e.g. mousing). Such user interface devices may be cumbersome to use and/or may not produce results at a desirable speed and/or level of accuracy. Thus, a need exists for a system and methods to allow a user of a computing device to work within a single unified working region.

### SUMMARY

In one general aspect, a computer program product can be tangibly embodied on a non-transitory computer-readable storage medium and include instructions that, when executed, are configured to perform a process. The instructions can include instructions to detect a gesture defined by an interaction of a user within a working volume defined above a surface, such as a surface above a keyboard portion of a computing device. Responsive to detecting the gesture, a gesture cursor control mode can be initiated within the computing device such that the user can manipulate the cursor by moving a portion of a hand of the user within the working volume. A location of the portion of the hand of the user relative to the surface can be identified within the working volume and a cursor can be positioned within a display portion of the computing device at a location within the display portion corresponding to the identified location of the portion of the hand of the user within the working volume.

In another general aspect, a computer-implemented method can include detecting at a computing device a gesture defined by an interaction of a user within a working volume defined above a surface. Based on detecting the gesture, a gesture cursor control mode within the computing device can be initiated such that the user can manipulate the cursor by moving a portion of a hand of the user within the working volume. A location of the portion of the hand of the user relative to the surface within the working volume can be identified and a cursor can be positioned within a display portion of the computing device at a location with the display portion corresponding to the identified location of the portion of the hand of the user within the working volume.

In yet another general aspect, a system can include instructions recorded on a non-transitory computer-readable medium and executable by at least one processor, the system can include a gesture classification module and a gesture tracking module. The gesture classification module is configured to detect a gesture defined by an interaction of a user within a working volume associated with a computing device. The working volume is defined above a surface. The gesture classification module is further configured to trigger initiation of a gesture cursor control mode when the gesture matches a predetermined gesture signature stored within the computing device. The gesture tracking module is configured to identify a position of a portion of a hand of the user within the working volume relative to the surface and position a cursor within a display portion of the computing device at a location corresponding to the position of the portion of the hand of the user within the working volume. The gesture tracking module is configured to move the cursor within the display portion of the computing device to correspond to movement of the portion of the hand of the user within the working volume when the computing device is in the gesture cursor control mode.

The details of one or more implementations are set forth in the accompanying drawings and the description below. Other features will be apparent from the description and drawings, and from the claims.

### BRIEF DESCRIPTION OF THE DRAWINGS

FIG. 1 is a schematic illustration of a computing device according to an implementation.

FIG. 2 is an illustration of a computing device, according to an implementation.

FIG. 3 is an illustration of the computing device of FIG. 2, showing a working volume associated with the computing device according to an implementation.

FIG. 4 is an illustration of the computing device of FIG. 2, showing a text based control mode of operation, according to an implementation.

FIG. 5 is an illustration of the computing device of FIG. 2, showing a gesture input by a user, according to an implementation.

FIG. 6 is an illustration of the computing device of FIG. 2 showing a gesture cursor control mode of operation, according to an implementation.

FIG. 7 is an illustration of the computing device of FIG. 2, showing a select and drag function, according to an implementation.

FIG. 8 is a flowchart that illustrates a method for triggering an operating a gesture cursor control mode of operation of a computing device, according to an implementation.

FIG. 9 is a flowchart that illustrates a method for switching between a gesture cursor control mode of operation and a text based control mode of operation of a computing device, according to an implementation.

### DETAILED DESCRIPTION

A virtual touch user interface system as described herein can use virtual touch input (e.g., gestures) and hand/finger gesturing on a surface, such as the surface of a keyboard portion of a computing device, to enable efficient and ergonomic text entry and selection/manipulation of user interface elements of the computing device. Using a capture device, such as a 3D camera, and recognition software, the selection and manipulation of user interface elements can be triggered using gestures by a user without using a physical input device, such as, for example, a mouse, touchpad or touch screen. The surface of a keyboard portion of the computing device and the working space or volume above the surface can be used for both text entry and selection and manipulation of user interface elements such that minimal hand motion is needed by a user. In other words, the user can work within a single unified working space to switch between one mode of user interaction (e.g., text entry) to another mode of user interaction (e.g., mousing or cursor control).

As described herein, modes of operation of a computing device can be triggered and operated by a virtual touch user interface system and methods. For example, a system and methods for changing between a text based (e.g. keyboard) control mode of operation and a gesture cursor control mode of operation of a computing device is described herein. The text based control mode of operation allows a user of the computing device to perform text entry or typing functions using, for example, a keyboard portion of the computing device. The gesture cursor control mode of operation of the computing device allows a user to maneuver and position a cursor within a display portion of the computing device by moving a portion of the user's hand (e.g., a finger tip) within a working space or region defined above a surface, such as the surface of the keyboard portion of the computing device or a surface next to the computing device. Thus, the user can control the cursor without physical contact with a separate input device such as a mouse, touchpad, trackpad or touch screen.

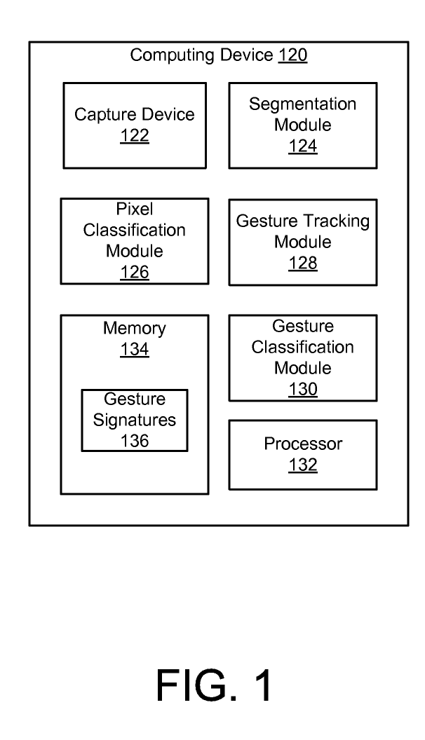

FIG. 1 is a schematic illustration of a computing device 120 on which the systems and methods described herein can be embodied. The computing device 120 can be, for example, a computing entity (e.g., a personal computing device, such as, a laptop computer, a desktop computer, a netbook computer, a tablet, a touchpad, etc.), a server device (e.g., a web server), a mobile phone, a personal digital assistant (PDA), e-reader, and/or so forth. The computing device 120 can be, for example, a wired device and/or a wireless device (e.g., wi-fi enabled device). The computing device 120 can be configured to operate based on one or more platforms (e.g., one or more similar or different platforms) that can include one or more types of hardware, software, firmware, operating systems, runtime libraries, and/or so forth.

As shown in FIG. 1, the computing device 120 can include a virtual user interface system that can include a capture device 122, a segmentation module 124, a pixel classification module 126, a gesture tracking module 128, and a gesture classification module 130. The computing device 120 can also include one or more processors 132, and a memory 134 that can store thereon one or more gesture signatures 136. The computing device 120 can also include, a display portion (not shown in FIG. 1) and a keyboard portion (not shown in FIG. 1).

In some implementations, the computing device 120 can represent a cluster of devices. In such an implementation, the functionality and processing of the computing device 120 (e.g., one or more processors 132 of the computing device 120) can be distributed to several computing devices of the cluster of computing devices.

In some implementations, one or more portions of the components shown in the computing device 120 in FIG. 1 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the gesture tracking module 128 can be, or can include, a software module configured for execution by at least one processor (not shown). In some implementations, the functionality of the components can be included in different modules and/or components than those shown in FIG. 1. For example, although not shown, the functionality of the gesture classification module 130 can be included in a different module, or divided into several different modules.

The components of the computing device 120 can be configured to operate within an environment that includes an operating system. In some implementations, the operating system can be configured to facilitate, for example, classification of gestures by the gesture classification module 130.

In some implementations, the computing device 120 can be included in a network. In some implementations, the network can include multiple computing devices (such as computing device 120) and/or multiple server devices (not shown). Also, although not shown in FIG. 1, the computing device 120 can be configured to function within various types of network environments. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can be have portions based on various protocols such as Internet Protocol (IP) and/or a proprietary protocol. The network can include at least a portion of the Internet.

The memory 134 of the computing device 120 can be any type of memory device such as a random-access memory (RAM) component or a disk drive memory. The memory 134 can be a local memory included in the computing device 120. Although not shown, in some implementations, the memory 134 can be implemented as more than one memory component (e.g., more than one RAM component or disk drive memory) within the computing device 120. In some implementations, the memory 134 can be, or can include, a non-local memory (e.g., a memory not physically included within the computing device 120) within a network (not shown). For example, the memory 134 can be, or can include, a memory shared by multiple computing devices (not shown) within a network. In some implementations, the memory 134 can be associated with a server device (not shown) on a client side of a network and configured to serve several computing devices on the client side of the network.

The display portion of the computing device 120 can be, for example, a liquid crystal display (LCD), a liquid emitting diode (LED) display, television screen, or other type of display device. In some implementations, the display portion can be projected on a wall or other surface or projected directly into an eye of the user. The optional keyboard portion of the computing device 120 can include, for example, a physical keyboard (e.g., includes physical keys that can be actuated by a user), a virtual keyboard (e.g., includes a touchscreen or sensing area), an optically projected keyboard (e.g., a projected display of a keyboard on a surface), or an optical detection keyboard (e.g., optically detects hand and/or finger motion of a user. In some implementations, the keyboard portion can also include various input devices, such as for example a touchpad or trackpad. In some implementations, the keyboard portion can be a device that can be electrically coupled to the computing device 120 (e.g., wired device). In some implementations, the keyboard portion can be integral with the computing device 120 (e.g., such as with a laptop). In some implementations, the keyboard portion can be wi-fi enabled to communicate wirelessly with the computing device 120. In further implementations, the computing device 120 can perform its functions without a keyboard portion using solely the virtual touch interface described in this document and/or other means of user interaction.

As used herein, a working volume may be the space or region above a surface associated with or near the computing device that is visible to the capture device 122. The working volume can be, for example, a working space or region in which a users of the computing device 120 places their hands during operation of the computing device 120, such as above a keyboard portion of the computing device. In other embodiments, the working volume may be a table surface proximate the computing device.

The capture device 122 can be, for example, a device configured to provide 3-dimensional (3D) information associated with the working volume defined above the keyboard portion of or a surface proximate to the computing device 120. For example, the capture device 122 can be, a camera, such as, for example, a 3D camera or a stereo camera (e.g., two or more cameras). In some implementations, the capture device 122 can be, for example, an above-the-surface sensing device (e.g., using infrared (IR) or ultrasound sensors embedded in the keyboard), or a time-of-flight camera (e.g., a range imaging camera system that the known speed of light and measures the time-of-flight of a light signal between the camera and the subject being imaged). In some implementations, the capture device 122 can be a monocular vision camera, in which case advanced computer vision algorithms are used to interpret the spatial structure of the scene. The capture device 122 can be a separate component that can be coupled to the computing device 120 or can be integrated or embedded within the computing device 120. For example, the capture device 122 can be embedded into a bezel portion of the computing device 120 along a top edge above the display portion of the computing device 120. In some implementations, the capture device 122 can be disposed below the display portion of the computing device 120. For example, the capture device 122 can be embedded within a lower bezel portion of the computing device 120.

The capture device 122 can be used to capture or collect 3D information (e.g., imaging data) associated the working volume defined above a surface, such as the surface of the keyboard portion of the computing device. The 3D information can be used to, for example, identify hand and/or finger motions of the user, for example, gesture inputs or interactions by the user as described in more detail below. The 3D information can be used by the gesture tracking module 128 and the gesture classification module 130 to identify a gesture input or interaction by a user of the computing device 120, and determine if the gesture input matches a gesture signature 136 stored within the memory 134. For example, one or more gesture signatures 136 can be predefined and stored within the memory 134 of the computing device 120.

In some implementations, a gesture signature 136 can be defined to trigger a change of an operational mode of the computing device 120 from a text based control mode of operation to a gesture cursor control mode of operation (or vice-versa) of the computing device 120. For example, in some implementations, a gesture signature 136 can include a prerecorded and stored gesture signature 136 that includes a clapping motion of a user's hands, and when a user performs a gesture interaction that matches that gesture signature 136, the system can change the mode of operation of the computing device 120 from the text based control mode of operation to the gesture cursor control mode of operation of the computing device 120.

In some implementations, a gesture input or interaction (also referred to herein as a “gesture”) by a user can be any type of non-electrical communication with the computing device 120. In some implementations, the gesture can include any type of non-verbal communication of the user such as a hand motion or hand signal of a user that can be detected by, for example, the capture device 122 of the computing device 120. In some implementations, detection of a gesture can be referred to as registration of the gesture, or registering of the gesture.

A gesture signature 136 can be, for example, a prerecorded and stored visual hand or finger motion of the user that can be used to trigger a function within the computing device 120. A gesture signature 136 can include a prerecorded and stored path or trajectory of the motion of a user's hand or a portion of a user's hand. A gesture signature 136 can be, for example, a special hand gesture to trigger a change of mode of operation (as discussed above), such as clapping or waving of the user's hands, a hovering gesture (e.g., the user's hand or finger is hovering or disposed over the surface), a click gesture (e.g., the user brings a finger and thumb together or the user taps a finger on the surface), a drag gesture (e.g., the user moves a finger along the surface). It should be understood that these are just example gestures and gesture signatures, as other gestures and gesture signatures can also be included.

When the computing device 120 is in the gesture cursor control mode of operation, the 3D information provided by the capture device 122 can be used to identify a location within the working space of a portion of a user's hand (e.g. a finger tip) and allow the user to maneuver and position a cursor within the display portion of the computing device 120 using that portion of the user's hand. In other words, rather than using a physical input device, such as, for example, a mouse or a trackpad or touchpad, to move the cursor, the user can move a portion of the user's hand, such as a finger tip, within the working volume to maneuver and position the cursor. When the text based control mode of operation is activated, the user can enter text (e.g., type) using, for example, the keyboard portion of the computing device 120. In some implementations, the computing device 120 may also include a physical input device such as a mouse or trackpad or touch pad, and can use the physical input device to maneuver the cursor while in the text based control mode of operation if desired.

In some implementations, the mode of operation of the computing device 120 can be changed by pressing or touching a selected portion (e.g., a selected key) of the surface (e.g. keyboard portion of the computing device 120). In some implementations, the same event (e.g., a gesture or actuating a special key) can be used to switch between the gesture cursor control mode of operation and the text based control mode of operation. In some implementations, the mode of operation can be changed when a time out occurs. For example, if the computing device 120 is in the gesture cursor control mode, the mode can be changed automatically to the text based control mode of operation after a predetermined time period. In some implementations, the text based control mode of operation can automatically be triggered when, for example, a text field within the display portion of the computing device 120 is selected while in the gesture cursor control mode. In some implementations, the gesture cursor control mode of operation can be automatically triggered when the cursor is moved out of a text field within the display portion of the computing device 120. For example, after the user has entered desired text into a text field and moves out of that text field, the gesture cursor control mode can be automatically triggered.

When the computing device 120 is in the gesture cursor control mode of operation, the gesture tracking module 128 can track the movement of a selected portion of the user's hand (e.g., finger tip) within the working volume above the surface, such as the keyboard portion of the computing device 120, and based on the location of the selected portion of the user's hand provide selection and manipulation of the a cursor within the display portion of the computing device 120. The gesture tracking module 128 can localize the position of the portion of the user's hand (e.g., finger tip) within the 3D working volume and estimate a distance from that position to the surface, such as a surface of the keyboard portion of the computing device 120. Thus, the gesture tracking module 128 can track and monitor the location of the portion of the user's hand (e.g., finger tip) relative to the surface. The gesture tracking module 128 can map the location or position of the selected portion of the user's hand to the display portion of the computing device 120 to provide absolute cursor positioning, rather than relative cursor positioning that is typically provided by a mouse or touchpad. In other words, there is a fixed, constant mapping between the working volume (e.g. region or space above the surface of the keyboard portion) and the display portion of the computing device, which allows the user to immediately position the cursor at the intended position, rather than having to consider the current position of the mouse cursor and navigating it in a relative manner to the desired position within the display portion of the computing device 120. In alternative implementations, the gesture cursor control mode can be implemented using such known relative positioning of the cursor motion.

The mapping between the user's 3D working volume and the 2D display region of the graphical interface may take different forms. In one implementation, the mapping takes the form of a 90 degree rotation around the axis of the display bezel followed by a projection, such that a forward-backward motion of the user's hand is mapped to an up-down motion on the display. In another implementation, the mapping takes a curved (or warped) form to better match the anatomy of the human hand. Here, for example, a curved motion of the finger tip during a “click” down motion towards the surface would be warped, so that the cursor does not move during the “click” but rather remains stationary on top of the currently selected interface element. In yet another implementation, the mapping is translated and scaled, such that a smaller region on the surface is mapped to the display or a larger region, or a region translated to the side. In further implementations, the scaling and translation parameters of the mapping adapt to the user's behavior during use.

The gesture cursor control mode of operation may also allow the user to perform click and drag functions by moving the portion of the user's hand along a surface, for example a surface of the keyboard portion of the computing device 120. For example, the user can move the selected portion of the user's hand (e.g., finger tip) to a location on the surface of the keyboard portion of the computing device 120 (e.g., at a non-zero distance from the surface of the keyboard portion), and the proximity to the surface of the keyboard portion can be detected to trigger a virtual touch event. For example, if the user wants to select an element on the display portion of the computing device, the user can, for example, point a finger tip to the element (e.g., the finger tip is hovering within the working volume) to place the cursor at a desired location on the display portion, and then move the finger tip to the surface to trigger a select function. The user can move the finger tip along the surface and a continuous dragging action can be performed. For example, the user can drag or move the selected element within the display portion of the computing device 120. In some implementations, the select function can be triggered when the user performs a particular gesture interaction. For example, a user gesture such as touching an index finger to a thumb can be a gesture interaction that triggers a select function.

To terminate the gesture cursor control mode of operation of the computing device 120 and trigger the text based control mode of operation, the user can perform a special gesture (as discussed above to trigger the gesture cursor control mode of operation), use a special key of the keyboard portion, or use a special portion of the surface to trigger the change. When in the text based control mode of operation, the user can key in text, use a mouse or touchpad or trackpad (if included on the computing device), and otherwise use the various functions provided on a text entry device (i.e. a keyboard portion) of the computing device 120 in a typical manner.

In some implementations, in operation, the capture device 122 can bring in raw data (e.g., imaging data) associated with the working volume and provide the raw data to the segmentation module 124. The segmentation module 124 can distinguish between the foreground and background of the raw imaging data and remove static parts of the imaging data, leaving only the dynamic parts of the imaging data. For example, the segmentation module 124 can identify the motion of the hand of the user within the working volume. The segmentation module 124 can then provide the segmented data to the pixel classification module 126. The pixel classification module can use the information provided by the segmentation module 124 to identify and classify various parts of the 3D information (e.g., imaging data). For example, the pixel classification module 126 can assign a class to individual pixels within the imaging data, such as for example, pixels associated with a hand, a finger, a finger tip, etc. The classification results provided by the pixel classification module 126 can be provided to the gesture tracking module 128. The segmentation module 124 and the pixel classification module 126 can each include any hardware and/or software configured to facilitate the processing of the 3D information provided by the capture device 122.

The gesture tracking module 128 can accumulate the classification results (from the pixel classification module 126) over time and construct a path or trajectory of the movement of a preselected portion of the user's hand (e.g., a finger tip) within the working volume. For example, the capture device 122 can collect 3D information associated with the working volume every, 30, 40, 50, 60, etc. times per second, and that information can be provided to the gesture tracking module 128 for each frame. The gesture tracking module 128 can accumulate the 3D information (e.g., imaging data) to construct a path or trajectory of the movement of the preselected portion of the user's hand (e.g., finger tip), and associate with the path various features related to the position and movement of the portion of the user's hand, such as distance from the surface, velocity, acceleration, etc. The gesture tracking module 128 can include any hardware and/or software configured to facilitate processing of the motion of the portion of the user's hand.

The constructed path(s) and associated features can be analyzed by the gesture classification module 130 to determine an associated gesture signature that matches the path of motion of the selected portion of the user's hand. For example, the path can be associated with a gesture input or interaction by the user as described above, and that gesture interaction can be compared to stored gesture signatures 136 within the memory 134 of the computing device 120.

The gesture classification module 130 can be configured to process (e.g., detect, analyze) one or more gesture interactions by a user with the computing device 120. The gesture classification module 130 can be configured to, for example, detect a gesture (i.e., a gesture interaction), define a representation of the gesture and/or trigger initiation of a gesture cursor control mode of the computing device 120 in response to the gesture. The gesture classification module 130 can include any hardware and/or software configured to facilitate processing of one or more gesture interactions associated with the computing device 120.

As discussed above, the capture device 122 can collect 3D information associated with the working volume, for example, every, 30, 40, 50, 60, etc. times per second, and the above described loop through the various modules can be processed for each frame (e.g., each image). In some implementations, the hardware and/or software of the gesture classification module 130 can be configured to actively monitor for a gesture interaction (e.g., actively scan or sample), or can be configured to passively detect a gesture interaction. For example, the capture device 122 can be configured to periodically capture/generate/process images to continuously monitor for an interaction (e.g., a hand signal) with respect to the computing device 120 that could be a gesture interaction.

In some implementations, the computing device 120 can include a special classifier module (not shown) that is separate from the gesture classification module 130 and that can be used to trigger the gesture cursor control mode of operation. For example, a special classifier module can receive imaging data from the capture device 122 and identify and compare a gesture provided by a user to a stored gesture signature. In such an implementation, the special classifier module compares the imaging information directly with stored gesture signature images.

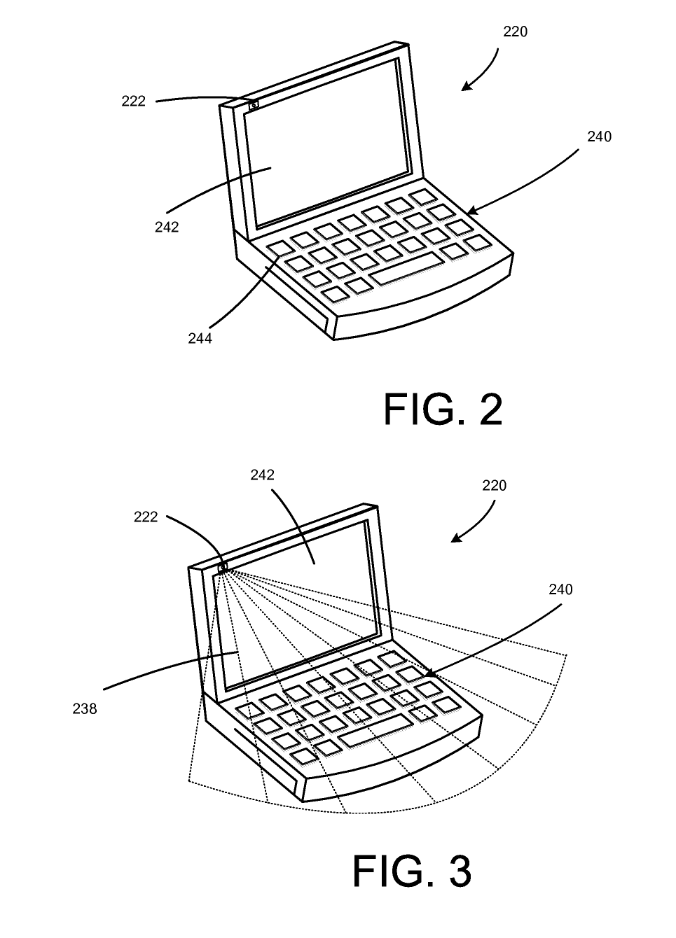

FIGS. 2-7 illustrate an example implementation and use of a computing device 220 that includes a virtual user input system as described above. As shown in FIG. 2, in this implementation, the computing device 220 is a laptop computer and includes a keyboard portion 240 and display portion 242. The keyboard portion 240 can include a plurality of keys 241 used on typical computing devices (e.g., a QWERTY keyboard layout). In this implementation, the plurality of keys include a special actuation key 244 that can be used to trigger a change of a mode of operation of the computing device 220 as described in more detail below.

The computing device 220 also includes a virtual user input system (also referred to herein as “system”) that includes a capture device 222 embedded within a top bezel portion 243 of the computing device 220. The capture device 222 can be, for example, a 3D camera or other device configured to provide 3D information as described above for computing device 120. The capture device 222 is shown embedded in a top left corner of the bezel portion 243, but as discussed above, the capture device 222 can alternatively be disposed at a different location along the top bezel portion 243 or along a bottom bezel portion 245 of the computing device 220.

Although not shown in FIGS. 2-7, the system can also include a segmentation module, a pixel classification module, a gesture tracking module, a gesture classification module, a memory, one or more gesture signatures stored within the memory and a processor as described above for computing device 120. These components can be the same as or similar to, and function the same as or similar to, the components of the same name described above for computing device 120.

As shown in FIG. 3, a working volume 238 can be defined above the keyboard portion 240. As described above, the working volume 238 can be defined as a space or region above a surface, such as the keyboard portion 240, in which users of the computing device 220 can place their hands during operation of the computing device 120. It should be understood that the working volume 238 is an example working volume as other working volumes, such as a space above a desk or table surface near the computing device, can be defined depending on factors, such as, for example, the range and scope of the capture device and the size and type of computing device, the size and type of keyboard portion and/or display portion, etc. As described above for computing device 120, the capture device 222 can be configured to provide 3-dimensional (3D) information associated with the working volume 238.

The 3D information collected by the capture device 222 can be used to, for example, identify hand and/or finger motions of a user, for example, gesture inputs or interactions by the user as described above for capture device 122. The 3D information can be used by the gesture tracking module and the gesture classification module to identify a gesture input or interaction by a user of the computing device 220, and determine if the gesture input matches a gesture signature predefined and stored within the memory of the computing device 220.

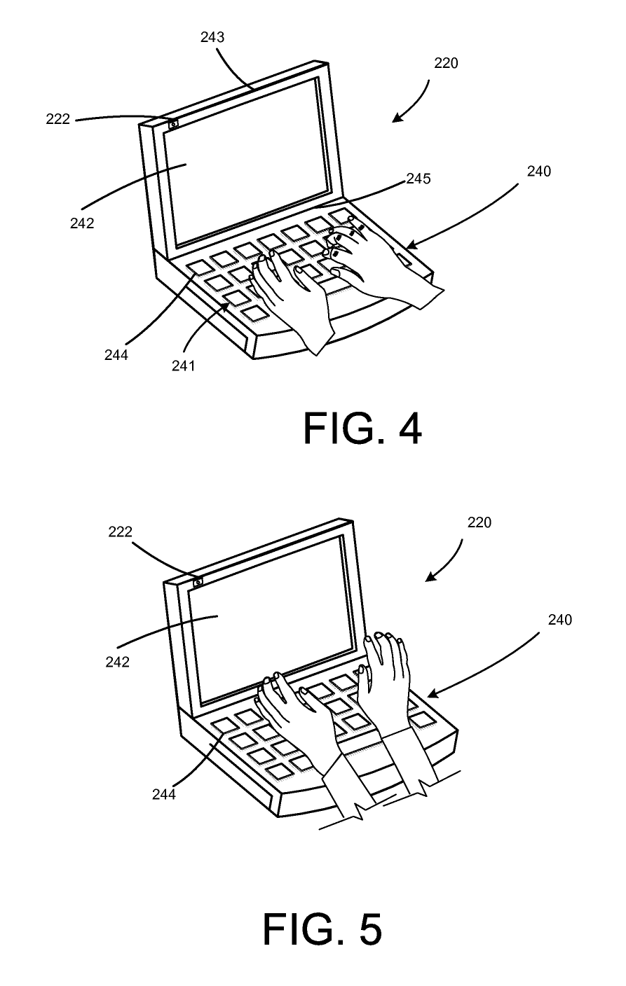

The computing device 220 can provide the user with two modes of interaction with the user while the user's hands remain within the working volume 238. Specifically, as discussed above for computing device 120, the computing device 220 can be switched or changed between a text based control mode of operation and a gesture cursor control mode of operation. FIG. 4 illustrates a user (e.g., the user's hands) using the computing device 220 in the text based control mode of operation. In this mode of operation, the user can use the plurality of keys 241, for example, to type or key-in desired text and perform functions as is typically done with known computing devices. While in the text based control mode of operation, the system can ignore any detected hand and/or finger motion of the user.

In this implementation, when the user desires to perform a mousing function, the user can perform or provide a gesture interaction or input to trigger the computing device 220 to change to the gesture cursor control mode of operation. For example, as shown in FIG. 5, in this example implementation, the gesture configured to trigger the gesture cursor control mode of operation includes the user holding both hands up within the working volume 238 as shown in FIG. 5. When the user performs this gesture input or interaction, the gesture classification module can compare the gesture interaction of the user to stored gesture signatures within the memory of the computing device 220. If the gesture interaction of the user matches the stored gesture signature assigned to trigger the gesture cursor control mode of operation, the gesture cursor control mode of operation will be initiated and the text based mode of operation will be terminated. In the gesture cursor control mode of operation the plurality of keys 241 on the keyboard portion 240 may not be functional to allow text entry.

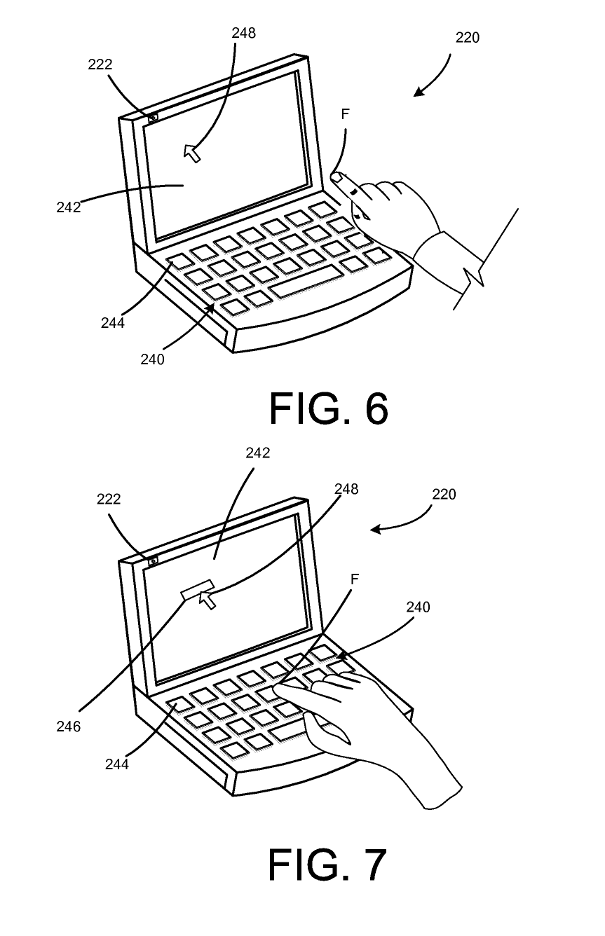

As discussed above, when the computing device 220 is in the gesture cursor control mode of operation the user can manipulate and position a cursor 248, shown in FIG. 6, within the display portion 242 by moving a portion of the user's hand within the working volume 238. In this example implementation, the portion of the hand of the user is a finger tip F as shown in FIG. 6. As described above for computing device 120, the virtual input system can identify and track the location of the finger tip F within the working volume 238, and map the location of the finger tip F to the display portion 242 to provide absolute positioning of the cursor 248 within the display portion 242. The user can use the finger tip F to move the cursor 248 within the display portion 242 in the same or similar manner as a mouse, touchpad or trackpad, while maintaining the hands of the user within the working volume 238.

The user can also perform various functions, such as for example, select, drag and drop functions while in the gesture cursor control mode. For example, the user can move the finger tip F to a surface of the keyboard portion 240 (as shown in FIG. 7), and the system can detect and identify the proximity of the finger tip F to the keyboard portion 240 and trigger a virtual touch event. For example, to select an element 246 within the display portion 242, the user can point to the element 246 such that the cursor is positioned or placed on the element 246, and then can select the element 246 by moving the finger tip F to the surface of the keyboard portion 240. The user can also drag the element 246 by sliding or moving the finger tip F along the surface of the keyboard portion 240. The user can release or drop the element 246 by moving the finger tip F above the surface of the keyboard portion 240. When the user desires to switch back to the text based control mode of operation, in this implementation, the user can tap or press the special actuation key 244 (shown in FIG. 2). This action will terminate the gesture cursor control mode of operation and trigger the text based control mode of operation. The user can switch between the text based control mode of operation and the gesture control mode of operation as desired.

In alternative implementations, rather than a special actuation key (e.g., 244) to trigger the change to the text based control mode of operation, a gesture interaction by the user can be used. The gesture interaction can be the same as or different than the gesture designated to trigger the gesture cursor control mode of operation. In some alternative implementations, the computing device 220 can use one or more special actuation key(s) to trigger both the text based control mode of operation and the gesture cursor control mode of operation.

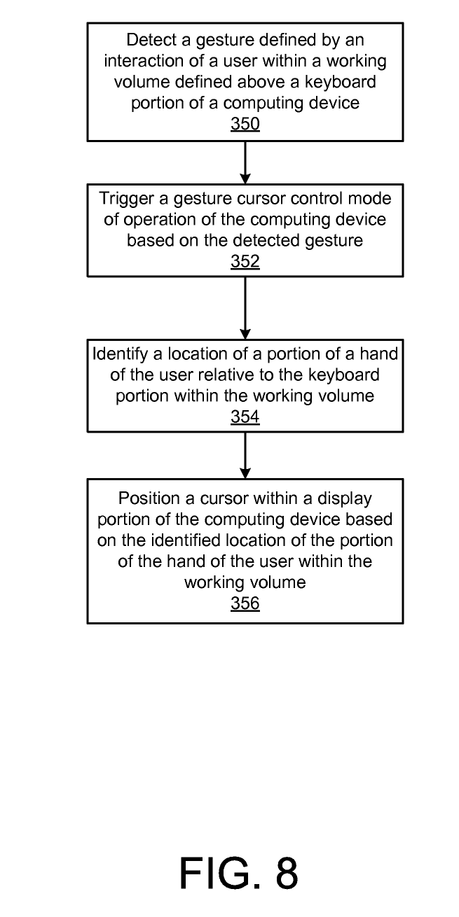

FIG. 8 is a flowchart illustrating a method of switching from a text based control mode of operation to a gesture cursor control mode of operation of a computing device. The method includes at 350, detecting at a computing device (e.g., 120, 220), a gesture defined by an interaction of a user within a working volume (e.g., 238) defined above a surface (e.g., 240) associated with or near the computing device. For example, as described herein, a capture device (e.g., 122, 222) can be used to capture 3D information associated with the working volume and that information can be used by a gesture tracking module (e.g., 128) and a gesture classification module (e.g., 130) to detect and analyze gesture interactions of the user.

At 352, based on the detected gesture interaction of the user, a gesture cursor control mode can be triggered within the computing device such that the user can manipulate cursor within a display portion (e.g., 242) of the computing device by moving a selected portion of the hand of the user (e.g., finger) within the working volume. For example, as described herein, the gesture classification module can compare the gesture interaction of the user to stored gesture signatures and if the gesture interaction matches a stored gesture signature configured to trigger a change to the gesture cursor control mode of operation, the gesture cursor control mode is triggered.

At 354, a location of the portion of a hand of the user (e.g., a finger tip) relative to the surface, such as the keyboard portion of the computing device, can be identified within the working volume. For example, the gesture tracking module can identify and track a position of the portion of the hand of the user based on the 3D information associated with the working volume provided by the capture device. At 356, a cursor can be positioned within the display portion of the computing device at a location within the display portion corresponding to the identified location of the portion of the hand of the user within the working volume. In other words, the gesture tracking module can map the location of the portion of the hand of the user to the display portion to provide absolute positioning of the cursor within the display portion.

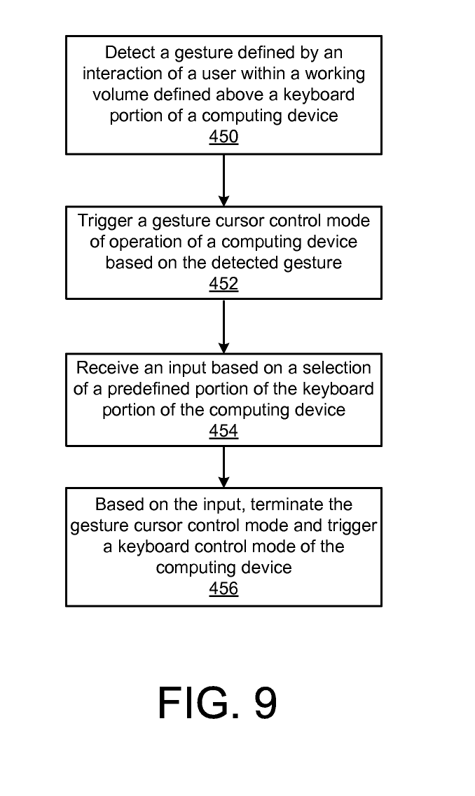

FIG. 9 is a flowchart illustrating a method of switching between a gesture cursor control mode and a text based control mode of a computing device. The method includes at 450, detecting at a computing device (e.g., 120, 220), a gesture defined by an interaction of a user within a working volume (e.g., 238) defined above a surface (e.g., 240) associated with or near the computing device. At 452, a gesture cursor control mode within the computing device can be triggered based on the detected gesture such that the user can manipulate a cursor within a display portion (e.g., 242) of the computing device by moving a selected portion of the hand of the user (e.g., a finger) within the working volume above the surface (e.g. the keyboard portion of the computing device).

At 454, an input can be received based on a selection by the user of a predefined portion of the surface (e.g. the keyboard portion of the computing device). For example, a selected key of the keyboard portion can be designated as a special actuation key (e.g., 244) configured to trigger a keyboard control mode of operation of the computing device. At 456, based on the input received, the gesture cursor control mode is terminated and the text based control mode of the computing device is triggered such that the user can type or enter text, etc. using the keyboard portion of the computing device.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, such as a machine-readable storage device (computer-readable medium), for processing by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A computer program product, the computer program product being tangibly embodied on a non-transitory computer-readable storage medium and comprising instructions that, when executed, are configured to cause a computing device to:
detect a predetermined gesture defined by an interaction of a user within a working volume defined above a surface;
responsive to detecting the predetermined gesture, initiate a gesture cursor control mode within the computing device, the gesture cursor control mode disabling text entry and enabling gesture interaction, which allows the user to manipulate the cursor by moving a portion of a hand of the user within the working volume;
identify a location of a predefined portion of the hand of the user relative to the surface within the working volume; and
position a cursor within a display portion of the computing device at a location within the display portion corresponding to the identified location of the portion of the hand of the user within the working volume.

2. The computer program product of claim 1, wherein the gesture cursor control mode is configured to:
map the working volume to the display portion of the computing device to provide absolute cursor positioning; and
trigger movement of the cursor within the display portion of the computing device based on movement of the portion of the hand of the user within the working volume.

3. The computer program product of claim 1, wherein the gesture cursor control mode is configured to detect when the portion of the hand of the user is at a non-zero distance from the surface and trigger a selection of an element within the display portion of the computing device based on a location of the cursor within the display portion associated with a position of the portion of the hand of the user when at the non-zero distance from the surface; and
initiate movement of the selected element within display portion based on movement of the portion of the hand while at a non-zero distance from the surface.

4. The computer program product of claim 1, further comprising instructions configured to:
receive an input based on a selection of a predefined portion of the surface, the input configured to trigger termination of the gesture cursor control mode and trigger a text entry mode of the computing device, the text entry mode disabling gesture interaction.

5. The computer program product of claim 1, wherein the instructions to identify a location of a portion of the hand of the user within the working volume includes instructions to localize a position of the portion of the hand of the user in the working volume and estimate a distance between the portion of the hand of the user relative to the surface using a capture device configured to provide 3-dimensional information associated with the working volume.

6. The computer program product of claim 1, wherein the instructions to identify a location of the portion of the hand of the user within the working volume includes receiving imaging data associated with the working volume.

7. The computer program product of claim 1, wherein the instructions to detect a gesture defined by an interaction of a user within the working volume includes receiving imaging data associated with the working volume.

8. A computer-implemented method, comprising:
detecting at a computing device a predetermined gesture defined by an interaction of a user within a working volume defined above a surface;
based on the detecting the gesture, initiating at the computing device a gesture cursor control mode within the computing device, the gesture cursor control mode disabling text entry and enabling gesture interaction, which allows the user to manipulate the cursor by moving a portion of a hand of the user within the working volume;
identifying a location of the portion of the hand of the user relative to the surface within the working volume; and
positioning a cursor within a display portion of the computing device at a location within the display portion corresponding to the identified location of the portion of the hand of the user within the working volume.

9. The computer-implemented method of claim 8, further comprising:
mapping the working volume to the display portion of the computing device to provide absolute cursor positioning; and
triggering movement of the cursor within the display portion of the computing device based on movement of the portion of the hand of the user within the working volume.

10. The computer-implemented method of claim 8, further comprising:
detecting when the portion of the hand of the user is at a non-zero distance from the surface and trigger a selection of an element within the display portion of the computing device based on a location of the cursor within the display portion of the computing device associated with a position of the portion of the hand of the user when at the non-zero distance from the surface; and
initiating movement of the selected element within display portion of the computing device based on movement of the portion of the hand while at a non-zero distance from the surface.

11. The computer-implemented method of claim 8, further comprising:
receiving an input based on a selection of a predefined portion of the surface; and
based on the input, terminating the gesture cursor control mode and triggering a text based control mode of the computing device, the text entry mode disabling gesture interaction.

12. The computer-implemented method of claim 8, wherein the identifying a location of a portion of the hand of the user within the working volume includes localizing a position of the portion of the hand of the user in the working volume and estimating a distance between the portion of the hand of the user relative to the surface using a capture device configured to provide 3-dimensional information associated with the working volume.

13. The computer-implemented method of claim 8, wherein the identifying a location of the portion of the hand of the user within the working volume includes receiving imaging data associated with the working volume.

14. The computer-implemented method of claim 8, wherein the detecting a gesture defined by an interaction of a user in the working volume includes receiving imaging data associated with the working volume.

15. A system including instructions recorded on a non-transitory computer-readable medium and executable by at least one processor, the system comprising:
a gesture classification module configured to detect a gesture defined by an interaction of a user within a working volume associated with a computing device, the working volume defined above a surface, the gesture classification module configured to trigger initiation of a gesture cursor control mode of operating the computing device when the gesture matches a predetermined gesture signature stored within the computing device, the gesture cursor control mode disabling text entry and enabling gesture interaction; and
a gesture tracking module configured to identify a position of a portion of a hand of the user within the working volume relative to the surface and position a cursor within a display portion of the computing device at a location corresponding to the position of the portion of the hand of the user within the working volume, the gesture tracking module configured to move the cursor within the display portion to correspond to movement of the portion of the hand of the user within the working volume when the computing device is in the gesture cursor control mode.

16. The system of claim 15, wherein the gesture tracking module is configured to localize the portion of the hand of the user within the working volume and estimate a distance between the portion of the hand of the user and the surface to identify the position of the portion of the hand of the user within the working volume.

17. The system of claim 15, wherein the portion of the hand is a portion of a finger and the gesture tracking module is configured to detect when the portion of the finger of the user is at a non-zero distance from the surface and trigger a selection of an element within the display portion of the computing device based on a location of the cursor within the display portion of the computing device associated with a position of the portion of the hand of the user when at the non-zero distance from the surface; and
initiate movement of the selected element within display portion based on movement of the portion of the hand while at a non-zero distance from the surface.

18. The system of claim 15, wherein the gesture classification module is configured to receive an input based on a selection of a predefined portion of the surface, the input configured to trigger termination of the gesture cursor control mode and trigger a text based control mode of the computing device.

19. The system of claim 15, further comprising:
a capture device configured to provide 3-dimensional information associated with the working volume to the gesture tracking module, the gesture tracking module configured to identify the location of the portion of the hand of the user within the working volume based on data received from the capture device.

20. The system of claim 15, further comprising:
an imaging device configured to provide imaging data associated with the working volume to the gesture classification module, the gesture classification module configured to detect the gesture defined by an interaction of the user within the working volume based on receiving imaging data associated with the working volume from the imaging device.
